(19) United States
(12) Patent Application Publication
(10) Pub. No.: US 2008/0306975 A1
(43) Pub. Date: Dec. 11, 2008

(54) Method for Copying and Manipulating Data

(75) Inventor: Nicholas David Michaelson, London (GB)

Correspondence Address: HAYES SOLOWAY P.C., 3450 E. SUNRISE DRIVE, SUITE 140, TUCSON, AZ, 85718, US

(73) Assignee: SILVER FOX LIMITED, Welwyn Garden City (GB)

(21) Appl. No.: 11/720,984

(22) PCT Filed: Dec. 2, 2005
(86) PCT No.: PCT/GB05/04621

§ 371 Date: Aug. 27, 2007

(30) Foreign Application Priority Data
Dec. 6, 2004 (GB) 0426659.9
Oct. 5, 2005 (GB) 0520230.4

(51) Int. Cl. G06F 17/30

(52) U.S. Cl. 707/101; 707/E17.002

(57) ABSTRACT

A method of compiling a series of output data elements to form an output data stream, said output data elements being derived from an input data source, said input data source comprising one or more input data elements, said method being performed by a processor and comprising the steps of: displaying, in a first region of a visual display, a representation of one or more input data elements; receiving input from a user selecting an input data element for inclusion in said series of output data elements; processing the selected input data element to form one or more output data elements; and adding said one or more output data elements to an output data stream.

This invention relates to a method and associated computer software and apparatus for copying and manipulating data from a data source. It is particularly applicable, but by no means limited, for preparing data to be printed as a series of labels.

### BACKGROUND TO THE INVENTION

In many industrial, commercial and business fields, computer data is often supplied in standard file types or formats, common examples being:
spreadsheet files (e.g. Microsoft (RTM) Excel (RTM) files (.xls file type))
comma separated values (CSV) (.csv file type)
database files (e.g. Microsoft (RTM) Access (RTM) files (.mdb file type))
text files (e.g. Microsoft (RTM) Word (RTM) files (.doc file type), plain text files (.txt file type), rich text files (.rtf file type) or WordPerfect (RTM) files (.wpd file type))
Adobe (RTM) portable document format files (.pdf file type)

Other file types will be known to those skilled in the art. Additionally, proprietary file types exist for certain computer programs used in industry, such as ids files for Fluke (RTM) cable label files.

The above file types, and others that will be known to those skilled in the art, or which have yet to be devised, serve as sources of data, and consequently will be referred to herein as data sources.

A data source generally comprises one or more data elements. A data element is defined herein as being any alphanumeric character string, value, operator, flag, image or graphical entity in the data source, and may be, for example, the alphanumeric content of a cell in a spreadsheet, the alphanumeric content of a field in a database record, or a string of alphanumeric characters in a text or pdf file. In more advanced applications, a data element could be a bitmap image, for example.

Often a data source is used to provide data for a subsequent operation such as printing, or for some other kind of processing. Such a data source will be referred to herein as an input data source. Data elements in an input data source will be referred to herein as input data elements.

When preparing data from an input data source for use in a subsequent operation such as printing (e.g. as a series of labels), it is often necessary for a user to select and prepare only certain desired input data elements from the input data source. A series of data elements, prepared as required for the subsequent operation, will be referred to herein as an output data stream. The data elements which constitute the output data stream will be referred to herein as output data elements. As described in more detail below, the preparation of the output data elements may include manipulation and/or repetition of one or more selected input data elements.

Conventionally, the selection of certain input data elements for subsequent processing (e.g. printing) has necessitated the user manually copying and pasting each required data element from the input data source into an output data source file on a personal computer (PC), and then printing the series of output data elements from the output data source file. This process of manually copying and pasting is laborious and time consuming.

A further problem is that, with conventional techniques, it is particularly cumbersome to select, copy and paste data from a plurality of input data sources in order to compile a single output data source.

Additionally, for example when preparing labels, it is often necessary for the user to repeat and/or manipulate selected data elements when preparing a series of output data elements, for example by adding prefixes, suffices or reference numbers. This process may involve repeating a single input data element and varying the prefix, suffix or reference number on each one—for example, repeating each of the input data elements MASTER and SLAVE nine times and applying a sequential reference number from 1 to 9 to each repeated data element, thereby obtaining the following series of eighteen output data elements: MASTER1, SLAVE1, MASTER2, SLAVE2, MASTER3, SLAVE3, MASTER4, SLAVE4, MASTER5, SLAVE5, MASTER6, SLAVE6, MASTER7, SLAVE7, MASTER8, SLAVE8, MASTER9, SLAVE9. One conventional method by which such a series would be prepared would involve the user manually copying and pasting the data elements on the PC and manually adding the reference number as a suffix. This manual process of copying, pasting and manipulating the data elements is laborious and time consuming, and is also prone to user error, particularly if a large number of output data elements are required. As mentioned above, the conventional process is made even more cumbersome if the input data is to be taken from a plurality of input data sources.

### SUMMARY OF THE INVENTION

According to a first aspect of the invention there is provided a method of compiling a series of output data elements to form an output data stream, said output data elements being derived from an input data source, said input data source comprising one or more input data elements, said method being performed by a processor and comprising the steps of: displaying, in a first region of a visual display, a representation of one or more input data elements; receiving input from a user selecting an input data element for inclusion in said series of output data elements; processing the selected input data element to form one or more output data elements; and adding said one or more output data elements to an output data stream.

This method advantageously facilitates the process by which the user may select desired data elements from an input data source and compile an output data stream.

Preferably the step of displaying further comprises displaying a representation of one or more of the output data elements in a second region of the visual display. This may be achieved using a plurality of windows in the display, for example using one window for the input data source and another window for the output data stream, and advantageously enables the user to see the output data stream being compiled as he selects each input data element, which in turn enables him to verify that the output data stream has the required content.

The input data source may be one of a plurality of input data sources available to the user from which to select an input data element. Accordingly, the step of displaying may further comprise displaying representations of input data elements from a plurality of input data sources simultaneously in the visual display. This may be achieved using a plurality of windows in the display, with each window corresponding to a different input data source, and advantageously enables the user to readily compile an output data stream derived from a number of different input data sources.

Preferably the step of receiving input from the user comprises detecting a single input action executed on a representation of the selected input data element. A single input action may be, for example, a single mouse click, and provides an extremely quick way in which to select an input data element. This one-click process is considerably faster than the traditional process of clicking in an input data source to select a data element, selecting a “copy” function, clicking elsewhere (e.g. in an output file) and then selecting a “paste” function.

The step of processing may comprise copying the selected input data element without alteration to form a single output data element. Alternatively, however, the step of processing may comprise executing a transform algorithm on the selected input data element. This transform algorithm is a very powerful feature of the present disclosure, and enables an intricate stream of output data elements to be derived from simple input data elements with relatively little user intervention.

Preferably said transform algorithm is operable to replace one or more alphanumeric characters within the selected input data element.

Preferably said transform algorithm is operable to exclude one or more alphanumeric characters from the selected input data element.

Preferably said transform algorithm is operable to add one or more alphanumeric characters to the selected input data element. Said one or more alphanumeric characters may be sequentially determined.

Preferably said transform algorithm is operable to repeat the selected input data element. The transform algorithm may be further operable to apply a different sequentially determined alphanumeric iteration to each of the repeated data elements.

Preferably said transform algorithm is operable to add one or more separator characters to an input data element. Said one or more separator characters may be cyclically determined.

Preferably said transform algorithm is operable to rearrange the positions of characters in the selected input data element.

The method may further comprise the step of performing a further processing operation on one or more of the output data elements in the output data stream. This advantageously enables the user to modify output data elements in the output data stream after the corresponding input data elements have been selected.

Preferably the further processing operation comprises executing a transform algorithm on the said one or more output data elements.

Preferably said transform algorithm is operable to replace one or more alphanumeric characters within the said one or more output data elements.

Preferably said transform algorithm is operable to exclude one or more alphanumeric characters from the said one or more output data elements.

Preferably said transform algorithm is operable to add one or more alphanumeric characters to the said one or more output data elements. Said one or more alphanumeric characters may be sequentially determined.

Preferably said transform algorithm is operable to repeat the said one or more output data elements. The transform algorithm may be further operable to apply a different sequentially determined alphanumeric iteration to each of the repeated data elements.

Preferably said transform algorithm is operable to add one or more separator characters to the said one or more output data elements. Said one or more separator characters may be cyclically determined.

Preferably said transform algorithm is operable to rearrange the positions of characters in the said one or more output data elements.

The method may further comprise a step of merging one or more output data elements.

The method may further comprise a preparatory step of merging two or more data sources to form said input data source, and/or another preparatory step of concatenating two or more input data elements to form a single input data element.

The input data source may be of a file type selected from a group comprising: spreadsheet files, comma separated value files, database files, text files, word processor files, portable document format files.

The method may further comprise a step of adding one or more output data elements, not derived from the input data source, to the output data stream. Such additional output data elements may be blank lines in the output data stream, or predetermined alphanumeric strings such as the word “SPARE”.

The method may further comprise a step of applying colouring to one or more of the output data elements. The colouring applied may be selected by the processor dependent on the value(s) of the said one or more output data elements. The applied colouring may represent the said value(s) in accordance with resistor colour coding.

The method may further comprise a step of saving the output data stream. This step may also include saving the details of any processing operations or transformation algorithms performed to generate the output data elements. This advantageously enables an “audit trail” to be performed retrospectively on an output data stream, to remind a user (or to enable him to discover) which processing steps were used to generate the output data stream.

The step of saving the output data stream may also include saving, as attachments or linked files, the one or more input data sources from which the output data elements were derived. This provides the advantage that if the user loses the original input data sources, he can still access them by virtue of their attachment or association with the saved output data stream, thereby enabling him to review the raw input data elements and, if necessary, modify them.

The method may further comprise saving the details of any processing operations or transformation algorithms performed to generate the output data elements. These details may be saved essentially as a set of processing instructions. This advantageously enables the user to apply the same processing instructions to other input data sources in the future, thereby facilitating and expediting the production of subsequent output data streams. Alternatively the user may choose to modify the processing instructions in the future and then apply the modified instructions to the same or different input data sources.

The method may further comprise a step of printing the output data stream, for example as a series of labels.

According to a second aspect of the invention there is provided a computer program executable on a processor to cause the processor to perform a method in accordance with the first aspect of the invention.

According to a third aspect of the invention there is provided a computer program stored on a data carrier, said computer program being executable on a processor to cause the processor to perform a method in accordance with the first aspect of the invention.

According to a fourth aspect of the invention there is provided a digital signal interpretable by a processor to cause the processor to perform a method in accordance with the first aspect of the invention.

According to a fifth aspect of the invention there is provided a processor programmed to execute a method in accordance with the first aspect of the invention. The processor may be incorporated in a personal computer (e.g. an IBM (RTM) compatible PC or an Apple (RTM) Macintosh (RTM)), a server, printing apparatus, a personal digital assistant, or another type of data processing equipment.

### BRIEF DESCRIPTION OF THE DRAWINGS

Embodiments of the invention will now be described, by way of example, and with reference to the drawings in which:

FIG. 1 illustrates an example of a computer system attached to a printer;

FIG. 2 is a schematic illustration of a screen display showing an input data source in a first window and an example of an output data stream in a second window;

FIG. 3 is a schematic illustration of a screen display showing two input data sources in separate windows and an example of an output data stream in a third window;

FIG. 4 is a schematic illustration of a screen display showing an input data source in a first window, a representation of a transform algorithm, and an example of an output data stream produced using the transform algorithm in a second window;

FIG. 5 is a schematic illustration of a screen display showing an input data source in a first window, a representation of a transform algorithm, and another example of an output data stream produced using the transform algorithm in a second window;

FIG. 6 illustrates a series of eight labels printed using the output data stream shown in FIG. 5;

FIG. 7 is a flow diagram showing processing steps executed by a processor in generating an output data stream from one or more input data sources;

FIG. 8 is another flow diagram showing processing steps executed by a processor in generating an output data stream from one or more input data sources, including the option of performing a transform operation on the output data stream;

FIG. 9 is another flow diagram showing processing steps executed by a processor in generating an output data stream from one or more input data sources, including the option of performing a transform operation on the output data stream, and a preparatory step of merging input data sources;

FIG. 10 is a flow diagram providing an example of processing steps performed on an input data element to generate one or more output data elements; and

FIG. 11 is a flow diagram providing an example of processing steps performed on an output data stream.

### DETAILED DESCRIPTION OF PREFERRED EMBODIMENTS

The present embodiments represent the best ways known to the applicant of putting the invention into practice. However they are not the only ways in which this can be achieved.

The present embodiments involve processing steps that may form part of a computer program or a set of instruction code, that may be executed on a computer or other processing device. The processing steps described herein are particularly suited to preparing data for printing—for example a series of labels—and the computer program or instruction code may be executed on a processor that forms part of a larger system such as label printing apparatus. The computer program or instruction code may be supplied on a data carrier such as a CD-ROM or floppy diskette, or may be downloadable as a digital signal over a network such as the Internet. Alternatively a processor arranged to execute the processing steps may be hard coded to implement the program.

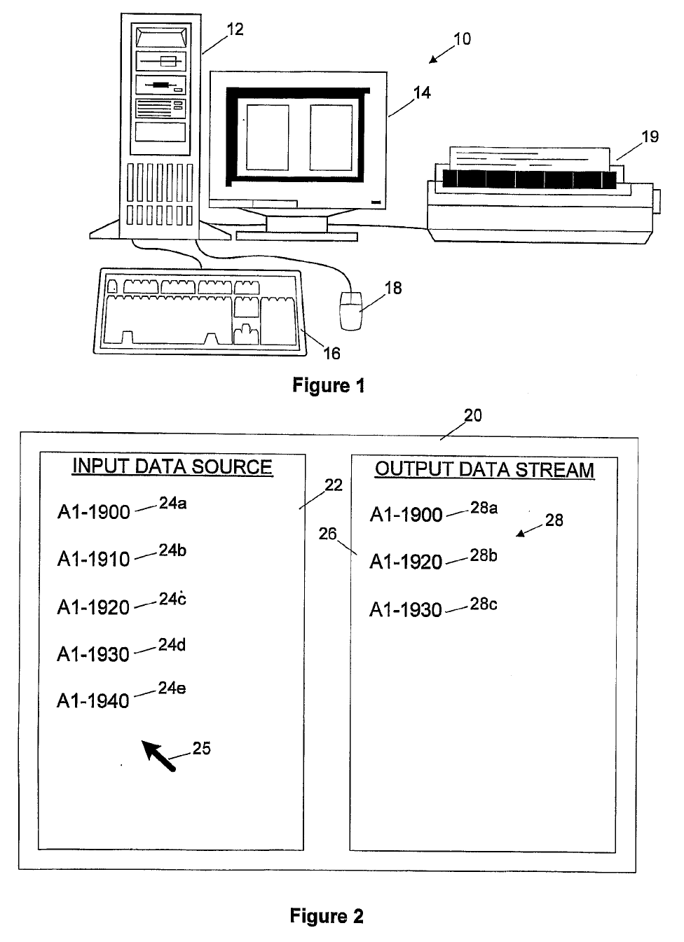

FIG. 1 illustrates an example of a computer system 10 arranged to implement embodiments of the present invention. The system 10 comprises a computer 12 which incorporates a processor, a visual display 14, a keyboard 16 and mouse 18 to receive user input, and a printer 19 which, in the preferred embodiments of the invention, is arranged to print labels.

The computer software used to implement the presently preferred embodiments uses a windows-based graphical user interface, although those skilled in the art will appreciate that other forms of user interface other than Microsoft (RTM) Windows (RTM) may be used.

FIG. 2 illustrates a first example of a windows-based visual display 20 with which the user interacts. In this embodiment, the computer processor is configured to display, in a first window 22, a visual representation of an input data source and one or more input data elements 24a-e which constitute the input data source. The input data source may be, for example, a spreadsheet file, a text file, a word processor file, a database file, a CSV file, or an Adobe (RTM) Acrobat (RTM) pdf file. In the case of a spreadsheet file, each cell, or each of a selected array of cells, forms a constituent input data element. Similarly, an input data element may be an alphanumeric string from a word processor file or a text file, a comma-separated entry in a CSV file, an entry in a database file, an alphanumeric string in a pdf file, or an image or other graphical entity. The software embodying the present invention is configured to enable such data files to be opened or imported, thereby enabling them to serve as input data sources and presenting the constituent data as input data elements 24a-e. If the input data source contains more input data elements than can be displayed simultaneously within the first window 22, vertical and/or horizontal scroll bars may be provided to enable the user to adjust which input data elements are displayed in the first window 22, in a manner that will be well known to those skilled in the art.

A second window 26 is also displayed in the visual display 20, preferably alongside the first window 22 and arranged such that the user can view both windows simultaneously. The second window 26 displays an output data stream 28. The output data stream 28 is essentially a series of output data elements (28a-c) that, through the operation of the software, are prepared for some subsequent operation such as printing (e.g. as a series of labels).

Generally, on starting a new processing operation, the output data stream 28 is empty. In use, the user manipulates the input devices 16, 18 to select one or more of the input data elements 24a-e from which the output data elements are to be derived. Preferably the user manipulates the mouse 18 and, in doing so, manoeuvres a cursor 25 over the input data elements 24a-e. Then, by clicking the mouse button once and once only on an input data element (e.g. 24a), the user may select that input data element for use in the output data stream 28. That is to say, by clicking on an input data element (or a representation thereof) in the input data source window 22, the user supplies input to the processor to indicate that that specific input data element (e.g. 24a) is desired to be used in the output data stream.

In alternative embodiments the software may require the user to click the mouse 18 more than once on a desired input data element, or to perform some other selection action such as pressing a key on the keyboard 16.

In the example shown in FIG. 2, the operation performed by the processor on the selected input data elements is simply that of copying the selected input data elements into the output data stream. In the example illustrated, the user has selected the first, third and fourth input data elements (24a, 24c, 24d) and these have been copied into the second window 26 to form output data elements in the output data stream 28. On receiving further user input (e.g. clicking on an on-screen icon marked “OK” or “FINISH” (not illustrated in the figures)), the user provides instruction to the processor that the output data stream 28 has now been completed. Once completed, the output data stream 28 may then be saved, exported or transmitted for some other processing operation such as being printed as a series of labels.

It will be appreciated that the action of providing a single click on each selected input data element, and in doing so causing that selected input data element to be copied into the output data stream, is an intuitive and extremely rapid way in which to copy selected data and thereby compile an output data stream. This process is significantly faster than the equivalent traditional process of compiling a series of selected data elements, which would involve selecting a desired input data element from a first data file, selecting a “copy” function, clicking on a second data file and then selecting a “paste” function, and repeating these steps until all the required data elements have been copied into the second data file.

As well as selecting individual input data elements as described above, the present method also enables complete columns or rows of input data elements (e.g. from a spreadsheet) to be selected in a single operation by clicking on a column header or row header on a representation of the spreadsheet displayed in the first window 22. Additionally, the user may select an entire column, for example, and then deselect unwanted input data elements from that column, so that only a desired set of input data elements are selected for use in the output data stream. The user may also select groups or blocks of input data elements in a single operation, for example by clicking and dragging the cursor 25 to select a group of input data elements (which may include a plurality of rows and a plurality of columns of spreadsheet data). Another method by which a group of input data elements may be selected is by the user clicking the cursor on a first input data element, pressing a key (e.g. the “Shift” key) on the keyboard, and then clicking on a second input data element, thereby selecting all the input data elements between (and including) said first and second input data elements. Again, this group of selected input data elements may cover a plurality of rows and a plurality of columns of spreadsheet data.

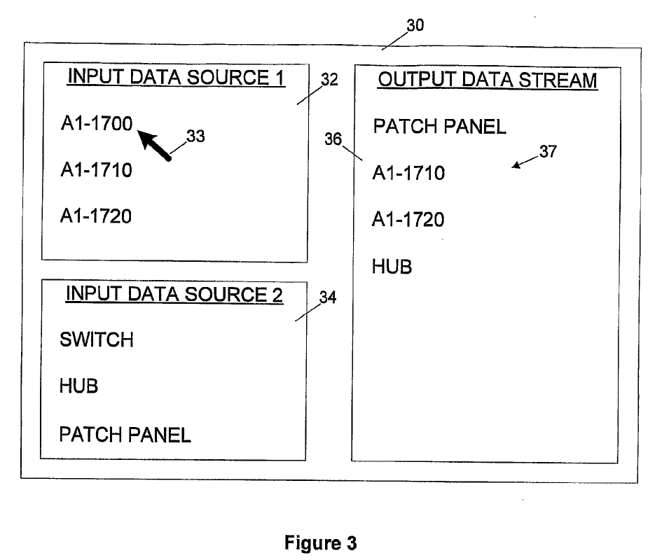

Data may be selected from more than one input data source for use in an output data stream. One manner in which this may be achieved is to merge two or more input data sources to form a single input data source, from which the user may then select input data elements. Alternatively, as illustrated in FIG. 3, a plurality of input data sources (in this case, two) may be displayed simultaneously in first and second windows 32 and 34 in the display 30, alongside which is a third window 36 in which the output data stream 37 is displayed. Using a cursor 33 as before, the user may then select desired input data elements from either input data source to form the output data stream 37. In the example shown, the user has selected, in sequence, the third input data element from the second window 34, the second and third input data elements from the first window 32, and the second input data element from the second window 34. On selection, these input data elements have been copied to form output data elements in the output data stream 37, which may then be saved, exported or transmitted for some other processing operation as before.

Whilst, in some cases, straightforward copying of selected input data elements to form the output data stream may be all that is required, the presently preferred embodiments provide more powerful functionality that enables selected input data elements to be transformed or otherwise manipulated in order to form the output data stream. The manipulation of the selected data elements is performed by a transform algorithm (which may alternatively be referred to as a transform matrix or a transform object).

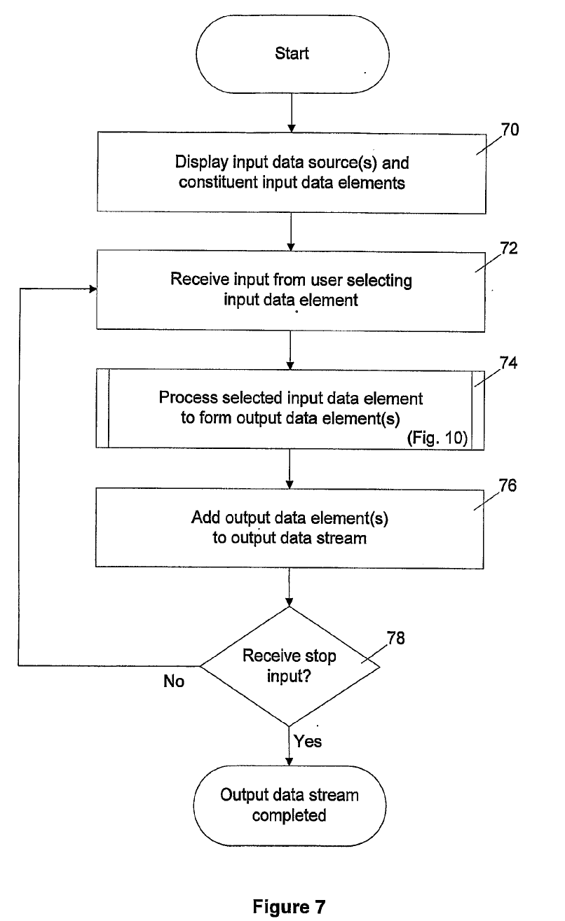

The transform algorithm may be applied to act on input data elements when each input data element is selected, effectively en route to the output data stream. That is to say, the user selects an input data element which is then passed to the transform algorithm for processing, and then the resultant output from the transform algorithm is sent to the output data stream. This process is illustrated in FIG. 7, which will be described in more detail below.

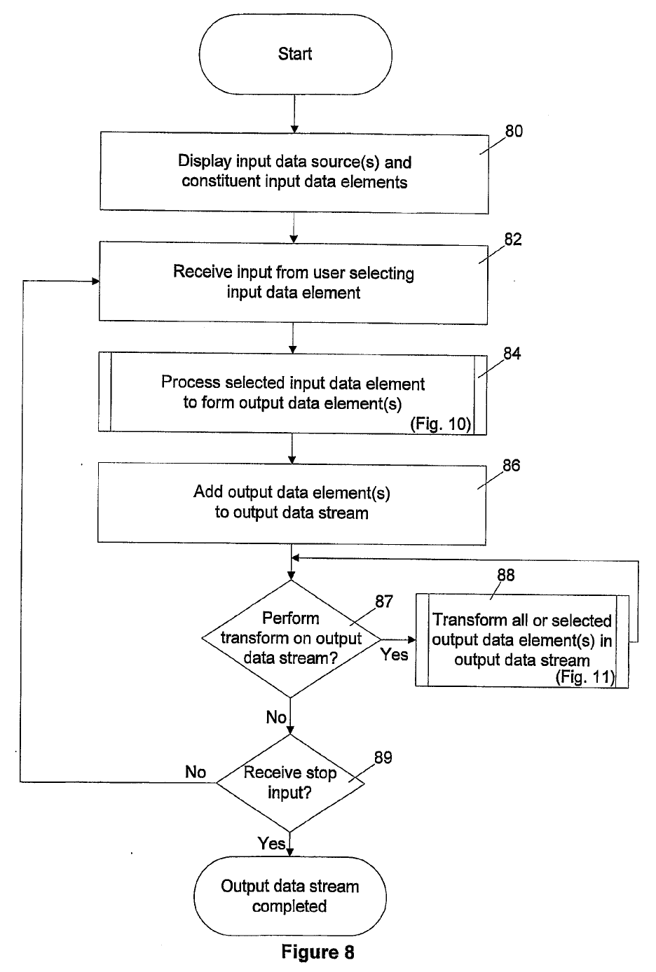

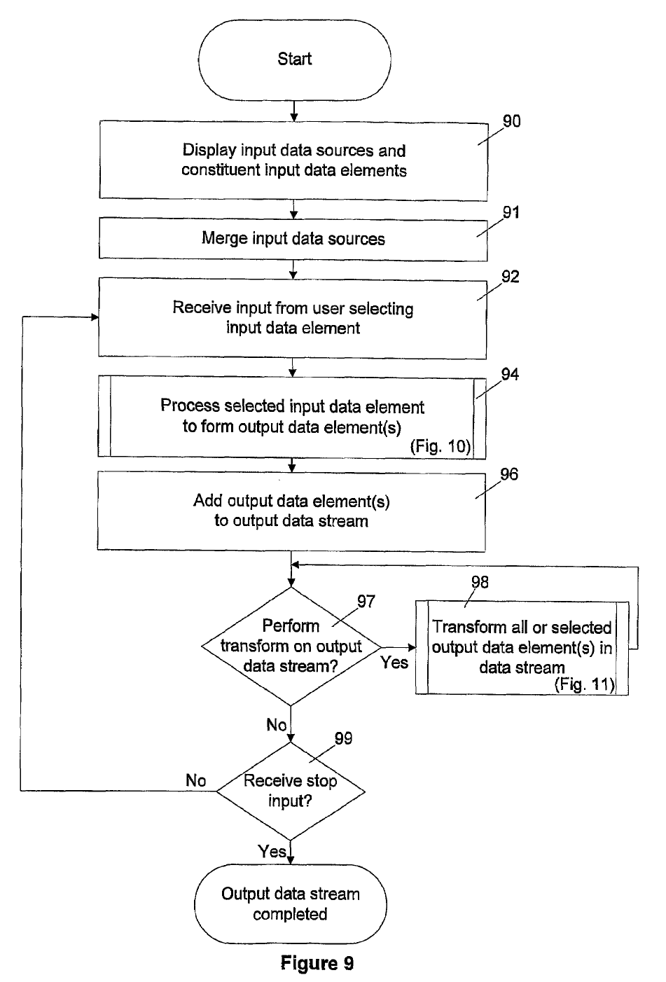

Alternatively, or in addition to the manner of operation of the transform algorithm outlined in the above paragraph, the transform algorithm may be applied to act on all (or a selected plurality) of the output data elements already in the output data stream. This process is illustrated in FIGS. 8 and 9, which will also be described in more detail below.

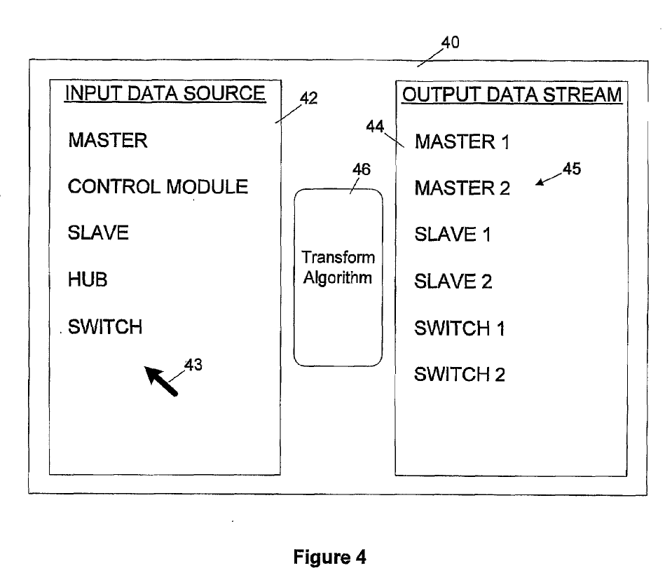

FIG. 4 illustrates a simple example of an application of the transform algorithm directly on input data elements as soon as they are selected. In this example, the display 40 includes an input data, source in a first window 42, and a second window 44 in which the output data stream 45 is displayed. Elsewhere in the display 40 (in this case, between the two windows 42, 44) is a representation 46 of the transform algorithm. The user may interact with the representation 46, e.g. using the mouse 18 and keyboard 16, to provide processing instructions for the transform algorithm to apply.

In the example shown in FIG. 4, the transform algorithm has been configured to repeat each selected input data element, adding a space character and then alternately either a numeral 1 or a numeral 2 to the repeated instances of the selected input data element. In the example shown, the user has selected the first, third and fifth input data elements from the input data source displayed in the first window 42, by clicking on them using a mouse cursor 43 as before. When each data element is selected, it is passed through the transform algorithm to give two output data elements that are then sent to the output data stream 45 displayed in the second window 44. In the case of the first selected input data element MASTER, this is processed by the transform algorithm to give two output data elements MASTER 1 and MASTER 2. Equivalent processing operations have been applied to the SLAVE and SWITCH input data elements on selection by the user, thereby resulting in the six output data elements shown in the output data stream 45 in FIG. 4. It will be appreciated that this process has enabled six output data elements to be generated in an intuitive, quick and logical manner using only three mouse clicks (once the transform algorithm has been configured).

Processing Operations Achievable by the Transform Algorithm

The transform algorithm may be configured by the user to apply any combination of the following types of processing operations on selected data elements. The following processing operations are given by way of examples only, and are not intended to represent an exhaustive list. Those skilled in the art will appreciate that other types of processing operations may be implemented by a transform algorithm in a similar manner.

Replace

Causes a specified alphanumeric string to be replaced with another alphanumeric string, or for one or more characters in specified positions in an alphanumeric string to be replaced by other characters in the same positions.

Exclude

Causes a specified alphanumeric string to be removed from the data elements.

Add

Causes a specified alphanumeric string or other characters to be added to the data elements, optionally in specified positions, anywhere within the data elements. Characters to be added may include numerals, and separators such as ‘|’, ‘/’, ‘\’ or ‘−’. Numerals and separators may be fixed (i.e. the same numeral or separator is applied to each data element) or the numerals or separators may change sequentially, such that the numeral or separator added to the data elements are not all the same. For example, numerals may be applied in the sequence 001, 002, 003, 004 etc. to each successive data element. Numerals and other alphanumeric characters may alternatively be “cogged”. With “cogging”, one of say two characters progressively moves through a sequence, and once that sequence has been completed, the other character moves to the next in its own sequence and the first character then repeats its sequence. For example, the second digit of a two digit numeral may increase in increments of 1 from 0 to 3, and on completing this sequence the first digit may increase by an increment of 1 from 1 to 3, thereby resulting in the following sequentially determined iterations of cogged numerals:

10, 11, 12, 13, 20, 21, 22, 23, 30, 31, 32, 33

Another example of cogging, in this case using letters of the alphabet, is:

aa, ab, ac, ad, ba, bb, bc, bd, ca, cb, cc, cd

Separators may be also be applied in an alternating or cyclic sequence, such as ‘/’, ‘\’, ‘/’, ‘\’ or ‘+’, ‘−’, ‘+’, ‘−’.

In order to add spacing to the output data stream, spaces or blank data elements (which may also be referred to herein as “blank cells”) may be added within or between output data elements. For example, blank cells may be added at specific locations within the output data stream, using start points and repeat factors or multiple location points.

Blank cells may also be added in predetermined positions within the output data stream. For example, a blank cell may be added after the ninth data element and then every n data elements after that.

Further, in order to add contextual information to the output data stream, cells containing fixed text strings may be added at specific locations within the output data stream, using start points and repeat factors or multiple location points. For example, the word “TEMPORARY” may be added after the fifth output data element and then every ten data elements after that. Alternatively, instead of fixed text strings being added, variable or sequentially-determined text strings may be introduced within the output data stream, for example to identify and number every tenth output data element.

Repeat

Causes an input data element to be repeated. This facility may often be used in conjunction with adding numerals or separators in a sequential manner, and the number of repetitions may be determined by the number of iterations in the sequence. For example, a selected input data element (e.g. XT) may be repeated three times, with each repeated instance having a fixed separator (e.g. ‘−’) and then a sequentially determined numeral added (resulting in the series of output data elements XT-1, XT-2, XT-3).

Shuffle

Causes the positions of characters in the data elements to be rearranged.

The above types of processing operations may be applied to individual input data elements on selection, en route to the output data stream, or may be applied to all or selected output data elements already in the output data stream.

In addition to rearranging character positions in the output data stream, one or more extra characters may optionally be introduced at any position within the rearranged data, in order to enhance the formatting of the output data elements.

Further in addition to rearranging character positions in the output data stream, if desired the rearranged data elements may be compressed in order to remove any embedded spacing.

The rearrangement or shuffle transformations may be confined to one or more specified ranges within the original source data elements. Alternatively, or in addition, the rearrangement or shuffle transformations may be constrained to exclude certain original source data elements.

Merge

Causes two or more data elements (e.g. input data elements in different columns of a spreadsheet) to be concatenated to give a single data element.

Input data elements or output data elements may be merged. When merging data elements, if desired the data elements may also be “padded” with spaces or other characters in order to force character alignment between successive merged data elements, and to enable more accurate positional arrangement of merged data elements. A separator, character or alphanumeric sequence may be inserted between merged data elements to enhance or augment the output. Padding and extra space removal techniques can be used in order that the resulting data elements are of a uniform length or common format, even if the length of the input data elements varies.

Colouring of Data Elements

Data elements within the output data stream may be coloured in any of a variety of colours, according to rules or conditions specified or selected by the user. The background to each data element may be coloured, or the alphanumeric characters themselves may be coloured. For example, a number within a data element may be given a background colour to indicate the said number as represented by resistor colour coding, thereby enabling easy recognition by electronics technicians. Such colouring may be applied automatically by the software. Numbers and letters could also be colour coded according to other rules or conditions, or to provide other styles of representation.

Data elements may be coloured as single entities. Alternatively, if desired, individual alphanumeric characters within data elements may be coloured differently.

If the background colour to a data element or character is coloured, then the data element or character itself may automatically be given a contrasting colour, and vice versa. For example, characters may automatically be coloured white if the background colour is black or dark blue. Conversely, the characters may automatically be coloured black if the background colour is white, yellow, red or green, for example.

Graphical Data Elements

The data elements which form the input data source, or which form the output data stream, or which are introduced or otherwise manipulated by the transform algorithm or other processing operations, may include images or other graphical entities. These may be, for example, icons, logos, pictures, symbols, etc, and may be in the form of bitmap images, or other image file formats as will be known to those skilled in the art, such as JPEG, GIF (graphics interchange format), TIFF (tagged image file format), PNG (portable network graphics), etc.

Worked Examples of Data Transformations

To illustrate some examples of data transformations, first consider an input data source comprising the following input data elements:

| | |
|---|---|
| A1-1900-FT | -004 |
| A1-1900-PT | -001 |
| A1-1900-PT | -038 |
| A1-1900-TT | -002 |
| A1-1900-EPT | -003 |
| A1-1900-PT | -003 |
| A1-1900-PT | -014 |
| A1-1900-PT | -043 |
| A1-1900-TT | -004 |

From this input data source, the first, second, fifth and ninth input data elements are selected for processing.

### EXAMPLE 1

### Copying Selected Elements Into Output Data Stream Without Transformation

A processing operation which simply comprises copying the selected input data elements into the output data stream gives the following series of output data elements:

Output data stream 1:

| | |
|---|---|
| A1-1900-FT | -004 |
| A1-1900-PT | -001 |
| A1-1900-EPT | -003 |
| A1-1900-TT | -004 |

In some instances, the above process of selecting and copying desired input data elements may be all that the user requires. In such instances, the above output data stream would then be sent for some subsequent operation such as printing. However, as described previously, it is possible to perform further processing operations on the data elements in the output data stream. Some examples of further processing operations carried out on the above output data stream are given below:

### EXAMPLE 2

### Repeating Using Numerical Sequence and Alternating Separators

Transform algorithm parameters:

| | |
|---|---|
| Front: | Add numerical sequence 1 to 4 |
| | Repeat for each data element |
| | Add alternating separators / and \ |

Output data stream 2:

| | |
|---|---|
| 1/A1-1900-FT | -004 |
| 2\A1-1900-FT | -004 |
| 3/A1-1900-FT | -004 |
| 4\A1-1900-FT | -004 |
| 1/A1-1900-PT | -001 |
| 2\A1-1900-PT | -001 |
| 3/A1-1900-PT | -001 |
| 4\A1-1900-PT | -001 |
| 1/A1-1900-EPT | -003 |
| 2\A1-1900-EPT | -003 |
| 3/A1-1900-EPT | -003 |
| 4\A1-1900-EPT | -003 |
| 1/A1-1900-TT | -004 |
| 2\A1-1900-TT | -004 |
| 3/A1-1900-TT | -004 |
| 4\A1-1900-TT | -004 |

(Specifying ‘front’ or ‘back’ in the transform algorithm parameters refers to whether the operation is to be applied to the front or back of the data elements.)

### EXAMPLE 3

### Adding Alternating Separators and a Numerical Sequence

Transform algorithm parameters:

| | |
|---|---|
| Front: | Add alternating separators * and # |
| | Repeat for each data element |
| Back: | Add alternating separators − and + |
| | Add numerical sequence 001 to 008 |

Output data stream 3:

| | |
|---|---|
| *A1-1900-FT | -004−001 |
| #A1-1900-FT | -004+002 |
| *A1-1900-PT | -001−003 |
| #A1-1900-PT | -001+004 |
| *A1-1900-EPT | -003−005 |
| #A1-1900-EPT | -003+006 |
| *A1-1900-TT | -004−007 |
| #A1-1900-TT | -004+008 |

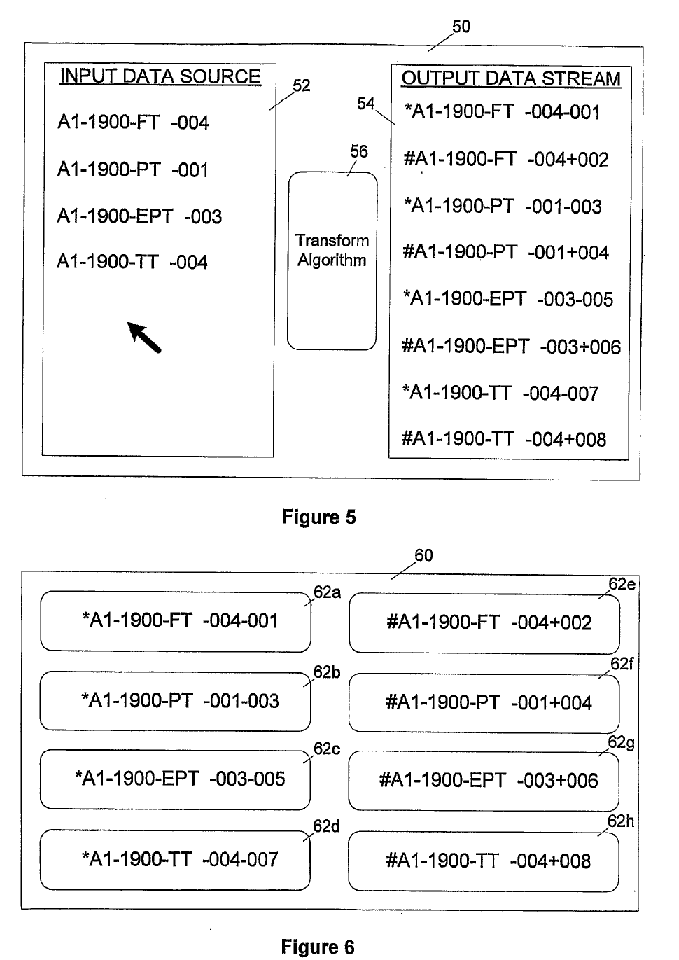

These processing operations are also illustrated in FIG. 5, which shows a display 50 with an input data source window 52 and an output data stream window 54 as described previously. However, in contrast to the processing steps described above, which were performed on data elements already in the output data stream, in the example of FIG. 5 the processing steps are performed on corresponding input data elements shown in the input data source window 52. The transform operations are nevertheless equivalent. The output data stream from FIG. 5 may be supplied to a printer, for printing as a series of labels, and FIG. 6 illustrates such a sheet 60 of printed labels 62a-h in which each label has been printed with an output data element from the output data stream of FIG. 5.

### EXAMPLE 4

### Shuffling to Change the Positions of Characters and Inserting Characters

Transform algorithm parameters:

| | |
|---|---|
| Shuffle: | Reverse position 15-17 |
| | Copy position 14 |
| | Copy position 8-13 |
| | Copy position 3-7 |
| | Insert ‘\|’ character |
| | Copy position 1 |
| | Copy position 2 |

Output data stream 4:

| | |
|---|---|
| 400--FT | -1900\|A1 |
| 100--PT | -1900\|A1 |
| 300--EPT | -1900\|A1 |
| 400--TT | -1900\|A1 |

### EXAMPLE 5

### Adding Alternating Separators, Adding Other Characters, Repeating and Shuffling

Transform algorithm parameters:

| | |
|---|---|
| Front: | Add alternating separators + and − |
| | Repeat for each data element |
| Back: | Add separator * and # |
| | Repeat for each data element |
| Shuffle: | Reverse position 15-17 |
| | Copy position 14 |
| | Copy position 8-13 |
| | Copy position 3-7 |
| | Insert ‘\|’ character |
| | Copy position 1 |
| | Copy position 2 |

Output data stream 5:

| | |
|---|---|
| +400--FT | -1900\|A1* |
| −400--FT | -1900\|A1* |
| +400--FT | -1900\|A1# |
| −400--FT | -1900\|A1# |
| +100--PT | -1900\|A1* |
| −100--PT | -1900\|A1* |
| +100--PT | -1900\|A1# |
| −100--PT | -1900\|A1# |
| +300--EPT | -1900\|A1* |
| −300--EPT | -1900\|A1* |
| +300--EPT | -1900\|A1# |
| −300--EPT | -1900\|A1# |
| +400--TT | -1900\|A1* |
| −400--TT | -1900\|A1* |
| +400--TT | -1900\|A1# |
| −400--TT | -1900\|A1# |

Although the transform algorithm parameters have been presented above in the form of lines of instruction code, in practice the user may be provided with a more user-friendly environment in which to specify the transform algorithm parameters required. For example, one or more graphical or pull-down menu options may be provided, to enable the user to select and specify the transform algorithm required. One or more data entry boxes may be displayed in the visual user interface environment, to enable the user to enter alphanumeric characters or symbols, for example “separator” characters, or to define an alphanumeric sequence to be added using the “add” processing operation. For example, to define a numerical sequence, the user may enter “start” and “end” values, a “step” value (to define the interval between values in the sequence) and a “repeat” value (to specify the number of times the sequence is to be repeated) into corresponding boxes. Once these values have been entered, the software can then generate the sequence without further user input. “Cogging” and other alphanumeric sequences may also be specified in such a manner. Source and destination boxes can also be displayed, and a drag/drop mechanism provided, in order to allow the characters within a data element to be rearranged into any order within the output.

### EXAMPLE 6

### Merging Data Elements From Different Columns of a Spreadsheet

In a first example of a way in which data elements may be merged, the data elements from two columns of a spreadsheet are simply concatenated, as follows:

| Column 1 | Column 2 | Merged data elements |
|---|---|---|
| 001 | A | 001A |
| 002 | WWD | 002WWD |
| 003 | 12AE | 00312AE |
| 004 | 1234UTR | 0041234UTR |
| 0045 | ERT | 0045ERT |
| 12345 | SERTY | 12345SERTY |
| 12 | A | 12A |
| 123456 | ABC | 123456ABC |

In a second example, the data elements from the two columns of the spreadsheet are again concatenated, but in this case a separator character ‘/’ is added between the data elements, as follows:

| Column 1 | Column 2 | Merged data elements |
|---|---|---|
| 001 | A | 001/A |
| 002 | WWD | 002/WWD |
| 003 | 12AE | 003/12AE |
| 004 | 1234UTR | 004/1234UTR |
| 0045 | ERT | 0045/ERT |
| 12345 | SERTY | 12345/SERTY |
| 12 | A | 12/A |
| 123456 | ABC | 123456/ABC |

In a third example, the data elements from the two columns of the spreadsheet are concatenated using a separator character (in this case ‘−’) and a padding technique is employed which in this case adds spaces such that the separator character is in a consistent position in the resulting data elements, as follows:

| Column 1 | Column 2 | Merged data elements |
|---|---|---|
| 001 | A | 001 -A |
| 002 | WWD | 002 -WWD |
| 003 | 12AE | 003 -12AE |
| 004 | 1234UTR | 004 -1234UTR |
| 0045 | ERT | 0045 -ERT |
| 12345 | SERTY | 12345 -SERTY |
| 12 | A | 12 -A |
| 123456 | ABC | 123456-ABC |

Procedural Flow Diagrams

FIGS. 7 to 11 illustrate procedural flow diagrams, to provide examples of the processing steps performed by the processor in implementing the presently preferred embodiments.

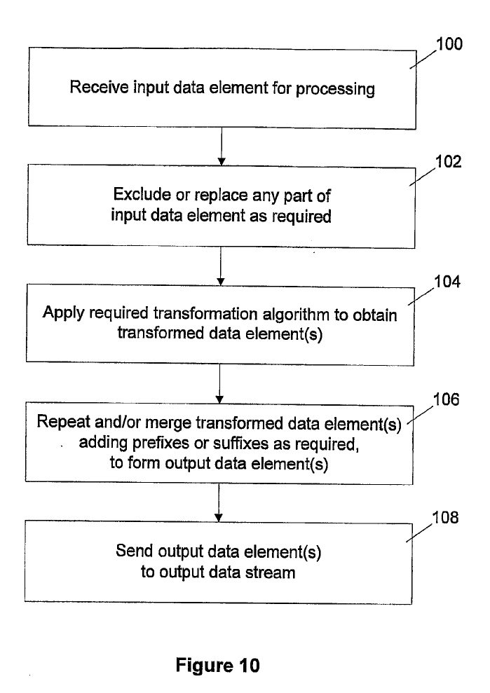

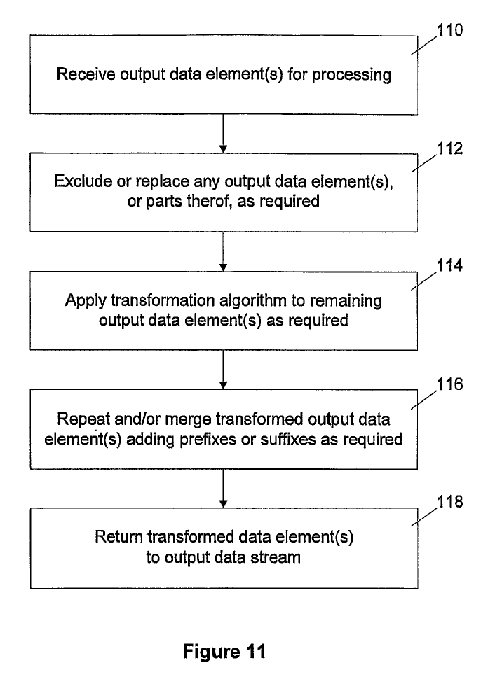

FIG. 7 refers to an embodiment whereby input data elements selected by the user from one or more input data sources are processed en route to the output data stream. Having started the procedure, the input data source(s) and some constituent data elements are displayed (70) on the display screen. Input is then received (72) from the user, e.g. using the mouse, to select an input data element (or a plurality thereof from which one or more output data elements are to be derived. The selected input data element is then processed (74) to form one or more output data elements. The processing step (74) is illustrated in FIG. 10. The one or more output data elements formed by the processing step are then added (76) to the output data stream. The user is permitted to select further input data elements, unless he provides a “stop” instruction (78) to the processor (e.g. by clicking on an “OK” or “FINISH” icon). Once such an instruction is received the output data stream is completed.

FIG. 8 illustrates a modified form of the process of FIG. 7, in which input data elements selected by the user may be processed en route to the output data stream, but in which transformations may also be performed on output data elements in the output data stream. Having started the procedure, the input data source(s) and some constituent data elements are displayed (80) on the display screen. Input is then received (82) from the user to select an input data element (or a plurality thereof) from which one or more output data elements are to be derived. The selected input data element is then processed (84) to form one or more output data elements. The processing step (84) is illustrated in FIG. 10. The one or more output data elements formed by the processing step are then added (86) to the output data stream. The user is then permitted (87) to perform a transform operation on the output data elements in the output data stream, in which case transformations are applied (88) as required—see FIG. 11), or to select further input data elements, unless a “stop” instruction (89) is supplied. Once such an instruction is received the output data stream is completed.

FIG. 9 illustrates a modified form of the process of FIG. 8, in which a plurality of input data sources may be merged into a single input data source before constituent data elements are selected by the user. Having started the procedure, the input data source(s) and some constituent data elements are displayed (90) on the display screen. Input may then be received from the user to instruct the processor to merge (91) the input data sources. The user may then select (92) an input data element (or a plurality thereof from which one or more output data elements are to be derived. The selected input data element is then processed (94) to form one or more output data elements. The processing step (94) is illustrated in FIG. 10. The one or more output data elements formed by the processing step are then added (96) to the output data stream. As above, the user is permitted (97) to perform a transform operation on the output data elements in the output data stream, in which case transformations are applied (98) as required—see FIG. 11), or to select further input data elements, unless a “stop” instruction (99) is supplied. Once such an instruction is received the output data stream is completed.

FIG. 10 illustrates the procedure performed by the processor in manipulating selected input data elements and passing them to the output data stream (as in steps 74, 84 and 94 of FIGS. 7, 8 and 9). The processor receives (100) the selected input data element and first excludes or replaces (102) any part of the input data element as required. A transformation is then applied (104) as required to the modified input data element to obtain one or more transformed data elements. These transformed data elements may then be repeated or merged, and suffixes and prefixes are added as required (106), thereby forming output data elements. The positions of the characters may also be shuffled as required. The resultant output data elements are then sent (108) to the output data stream.

FIG. 11 illustrates the procedure performed by the processor in transforming output data elements already in the output data stream and then returning them to the output data stream (as in steps 88 and 98 of FIGS. 8 and 9). The processor receives (110) the output data element(s) for processing, and first excludes or replaces (112) any of the output data elements, or parts thereof, as required. The required transformation is then applied (114) to the remaining output data elements to obtain one or more transformed data elements. These transformed data elements may then be repeated or merged, and suffixes and prefixes are added as required (116). The positions of the characters may also be shuffled as required. The resultant output data elements are then returned (118) to the output data stream.

The Output Data Stream

The output data stream is essentially an alphanumeric stream with the constituent output data elements being separated by ‘carriage return’ separators. Once completed, the output data stream may then be sent directly for a subsequent operation such as printing, or output to another program or file such as a spreadsheet or database, or output into a further data processing subroutine within the same program, or saved as a data file for future reference or use. For example, the user may revert to the saved output data stream to copy selected output data elements from the output data stream. He may then import or paste the copied output data elements into another spreadsheet, or back into the input data source from which the output data stream had been derived, or into another file or software application.

The output data stream may be manipulated, either manually by the user, or automatically by the processor in accordance with user instructions, to add blank lines (essentially further ‘carriage return’ separators) or other lines of alphanumeric text (e.g. the word “SPARE”) between certain output data elements. For example, the processor could be configured such that the word “SPARE” appears every fifth line in the output data stream, and that one blank line is inserted after every ten non-blank lines. If printed as a series of labels, blank lines or the word “SPARE” provide the user with blank or spare labels which be desirable in certain applications. Furthermore, the presence of regular blank lines in the output data stream may aid a user who is subsequently required to read through the lines of output data elements, e.g. to verify the content.

The details of any processing operations or transform algorithms performed to generate the output data elements may also be saved, either with the output data stream, or in a linked or attached file. This enables an ‘audit trail’ to be performed retrospectively on an output data stream, to remind a user (or to enable him to discover) which processing steps were used to generate the output data stream.

Alternatively, the details of any processing operations or transformation algorithms performed to generate the output data elements may be saved in a separate data file, essentially as a set of processing instructions. This enables the user to apply the same processing instructions to other input data sources in the future (e.g. as a ‘template’). Alternatively the user may choose to modify the processing instructions in the future and then apply the modified instructions to the same or different input data sources.

The input data source(s) from which the output data elements were derived may also be saved along with the output data stream. The input data source(s) may be saved as attachments or linked files associated with the saved output data stream. This provides the advantage that if the user loses the original input data sources, he can still retrieve them from the saved output data stream, thereby enabling him to review the raw input data elements and, if necessary, modify them.

Example of a Programmer's Outline Specification for the Transform Algorithm

By way of guidance to a computer programmer seeking to program a transform algorithm or transform object, below is an outline specification derived from an implementation of the Transformation object classes, which provides an example of how a transformation filter can be implemented using object oriented technology.

Transforms are performed by a list of transformation objects, each of which is descended from a common base TTransObj.

The TTransObj is the base class. This object knows how to place itself on a data stream for filing, knows if the transformation process applies to the data it is being offered (by coordinates), and knows if it is active.

TTransReplace is a TTransObj derived object and acts as a string replace object. If it is passed a matching string, it replaces it before placing the data in the output stream. Otherwise the unmodified string is passed on.

TReformat class is a basic object for a single of data reconstruction event. It knows how to perform a single manipulation on an input string.

TTransSplit class is a TTransObj derived object that groups an unlimited number of TReformat objects and enacts their instructions sequentially on the input data stream, placing the shuffled data onto the output stream.

New TTransObj derived classes can be easily defined for additional transformation requirements as they arise.

Finally, there is a TTransformList class, which contains an open-ended list of TTransObj derived objects. The master object for all transformations and acts as the big end of the “funnel”, taking the input stream and returning a fully manipulated output. The transformations are double swept, with specific (by coordinate) transforms being applied before generic (no coordinate) transforms.

Some Class Implementation Notes

All objects override a streamIn and a streamOut function to enable saving and loading the transformation data

All active objects include a Get(string) function that returns a transformed string {TTransObj}
State Functions:
   Am I global?
   Am I active?
Coordinate Setting
{TTransformList}

Allows addition, replacement and deletion of individual transformation objects.

1-46. (canceled)

47. A method of compiling a series of output data elements to form an output data stream, said output data elements being derived from an input data source, said input data source comprising one or more input data elements, said method being performed by a processor and comprising the steps of:
displaying, in a first region of a visual display, a representation of one or more input data elements;
receiving input from a user selecting an input data element for inclusion in said series of output data elements;
processing the selected input data element to form one or more output data elements; and
adding said one or more output data elements to an output data stream.

48. A method as claimed in claim 47, wherein the step of displaying further comprises displaying a representation of one or more of the output data elements in a second region of the visual display.

49. A method as claimed in claim 47, wherein said input data source is one of a plurality of input data sources available to the user from which to select an input data element.

50. A method as claimed in claim 49, wherein the step of displaying further comprises displaying representations of input data elements from a plurality of input data sources simultaneously in the visual display.

51. A method as claimed in claim 47, wherein the step of receiving input from the user comprises detecting a single input action executed on a representation of the selected input data element.

52. A method as claimed in claim 47, wherein the step of processing comprises copying the selected input data element without alteration to form a single output data element.

53. A method as claimed in claim 47, wherein the step of processing comprises executing a transform algorithm on the selected input data element.

54. A method as claimed in claim 53, wherein said transform algorithm is operable to replace one or more alphanumeric characters within the selected input data element.

55. A method as claimed in claim 53, wherein said transform algorithm is operable to exclude one or more alphanumeric characters from the selected input data element.

56. A method as claimed in claim 53, wherein said transform algorithm is operable to add one or more alphanumeric characters to the selected input data element.

57. A method as claimed in claim 56 wherein said one or more alphanumeric characters are sequentially determined.

58. A method as claimed in claim 53, wherein said transform algorithm is operable to repeat the selected input data element.

59. A method as claimed in claim 57 wherein said transform algorithm is operable to repeat the selected input data element and to apply a different sequentially determined alphanumeric iteration to each of the repeated data elements.

60. A method as claimed in claim 56, wherein said transform algorithm is operable to add one or more separator characters to an input data element.

61. A method as claimed in claim 60, wherein said one or more separator characters are cyclically determined.

62. A method as claimed in claim 53, wherein said transform algorithm is operable to rearrange the positions of characters in the selected input data element.

63. A method as claimed in claim 47, further comprising the step of performing a further processing operation on one or more of the output data elements in the output data stream.

64. A method as claimed in claim 63, wherein the further processing operation comprises executing a transform algorithm on the said one or more output data elements.

65. A method as claimed in claim 64, wherein said transform algorithm is operable to replace one or more alphanumeric characters within the said one or more output data elements.

66. A method as claimed in claim 64, wherein said transform algorithm is operable to exclude one or more alphanumeric characters from the said one or more output data elements.

67. A method as claimed in claim 64, wherein said transform algorithm is operable to add one or more alphanumeric characters to the said one or more output data elements.

68. A method as claimed in claim 67, wherein said one or more alphanumeric characters are sequentially determined.

69. A method as claimed in claim 64, wherein said transform algorithm is operable to repeat the said one or more output data elements.

70. A method as claimed in claim 68 wherein said transform algorithm is operable to repeat the said one or more output data element and apply a different sequentially determined alphanumeric iteration to each of the repeated data elements.

71. A method as claimed in claim 67, wherein said transform algorithm is operable to add one or more separator characters to the said one or more output data elements.

72. A method as claimed in claim 71, wherein said one or more separator characters are cyclically determined.

73. A method as claimed in claim 64, wherein said transform algorithm is operable to rearrange the positions of characters in the said one or more output data elements.

74. A method as claimed in claim 47, further comprising a step of merging one or more output data elements.

75. A method as claimed in claim 47, further comprising a preparatory step of merging two or more data sources to form said input data source.

76. A method as claimed in claim 47, further comprising a preparatory step of concatenating two or more input data elements to form a single input data element.

77. A method as claimed in claim 47, wherein the input data source is of a file type selected from a group comprising: spreadsheet files, comma separated value files, database files, text files, word processor files, portable document format files.

78. A method as claimed in claim 47, further comprising a step of adding one or more output data elements, not derived from the input data source, to the output data stream.

79. A method as claimed in claim 47, further comprising a step of applying colouring to one or more of the output data elements.

80. A method as claimed in claim 79, wherein the colouring applied is selected by the processor dependent on the value(s) of the said one or more output data elements.

81. A method as claimed in claim 80, wherein the applied colouring represents the said value(s) in accordance with resistor colour coding.

82. A method as claimed in claim 47, further comprising a step of saving the output data stream.

83. A method as claimed in claim 82, wherein the step of saving the output data stream also includes saving the details of any processing operations or transformation algorithms performed to generate the output data elements.

84. A method as claimed in claim 82, wherein the step of saving the output data stream also includes saving, as attachments or linked files, the one or more input data sources from which the output data elements were derived.

85. A method as claimed in claim 47, further comprising saving the details of any processing operations or transformation algorithms performed to generate the output data elements.

86. A method as claimed in claim 47, further comprising a step of printing the output data stream.

87. A computer program executable on a processor to cause the processor to perform a method as claimed in claim 47.

88. A computer program stored on a data carrier, said computer program being executable on a processor to cause the processor to perform a method as claimed in claim 47.

89. A digital signal interpretable by a processor to cause the processor to perform a method as claimed in claim 47.

90. A processor programmed to execute a method as claimed in claim 47.

91. A digital signal interpretable by a processor to cause the processor to perform a method as claimed in claim 47.

92. A processor programmed to execute a method as claimed in claim 47.
